(19) United States
(12) Patent Application Publication
(10) Pub. No.: US 2024/0204237 A1
(43) Pub. Date: Jun. 20, 2024

(54) ELECTROCHEMICAL DEVICE AND METHOD FOR PRODUCING SAME

(71) Applicant: Panasonic Intellectual Property Management Co., Ltd., Osaka (JP)

(72) Inventors: Keisuke MASUNAGA, Tokyo To (JP); Kouji UEOKA, Nara Ken (JP); Kazuaki YAMASHITA, Hokkaido (JP)

(73) Assignee: Panasonic Intellectual Property Management Co., Ltd., Osaka (JP)

(21) Appl. No.: 18/288,472

(22) PCT Filed: Apr. 27, 2022
(86) PCT No.: PCT/JP2022/019064

§ 371 Date: Oct. 26, 2023

(30) Foreign Application Priority Data
Apr. 30, 2021 (JP) 2021-077621

(51) Int. Cl. H01M 10/04; H01M 10/0565; H01M 10/0587; H01M 50/46; H01M 50/559

(52) U.S. Cl. CPC H01M 10/0431; H01M 10/0565; H01M 10/0587; H01M 50/461; H01M 50/559; H01M 2300/0028

(57) ABSTRACT

An electrochemical device includes a first electrode, a second electrode, a separator interposed between the first electrode and the second electrode, an electrolyte, a lead terminal electrically connected to one electrode of the first electrode and the second electrode, and a protection tape covering the lead terminal. The one electrode includes a current collecting foil and a mixture layer provided on the current collecting foil. The current collecting foil has a first region covered with the mixture layer, and a second region not covered with the mixture layer and exposing a surface of the current collecting foil. The protection tape is allowed to adhere to the lead terminal provided at the second region of the current collecting foil, and to at least a portion of a third region which is a part of the second region and not covered with the lead terminal.

### TECHNICAL FIELD

The present invention relates to an electrochemical device and a production method thereof.

### BACKGROUND ART

An electrochemical device includes a pair of electrodes and an electrolyte, and at least one of the pair of electrodes includes an active material capable of adsorbing and desorbing ions. A separator is interposed between the pair of electrodes. An electric double-layer capacitor, as an example of the electrochemical device, has a longer life, can be quickly charged, and has excellent output characteristics compared with secondary batteries, and therefore widely used as a backup power source.

Patent Literature 1 proposes covering the negative electrode terminal with a protection tape to suppress lithium deposition on the negative electrode terminal upon predoping in a lithium ion capacitor.

### CITATION LIST

### Patent Literature

### PTL 1

Japanese Unexamined Patent Publication No.2018-67595

### SUMMARY OF INVENTION

Recently, achievement of a higher capacity in an electrochemical device is demanded at a high level. For the higher capacity, an attempt has been made to decrease the thickness of the current collector and the thickness of the separator. Meanwhile, for achieving the higher capacity, an attempt has been also made to increase the thickness of the mixture layer (active material layer) supported by the current collector.

Thinner current collector and separator decrease the electrode strength, and allow electrode damages or short circuits to be caused by external impacts and the like. To cope with this, improvement in shock resistance can be expected by attaching a protection tape to a terminal connection portion where loads are particularly applied. However, an excellent adhesion status cannot be achieved between the electrode and the protection tape, which may cause an insufficient shock resistance strength.

In view of the above, an aspect of the present invention relates to an electrochemical device including a first electrode, a second electrode, and a separator interposed between the first electrode and the second electrode, an electrolyte, a lead terminal electrically connected to at least one electrode of the first electrode and the second electrode, and a protection tape covering the lead terminal, wherein the at least one electrode includes a current collecting foil and a mixture layer provided on the current collecting foil, the current collecting foil has a first region covered with the mixture layer and a second region not covered with the mixture layer and exposing a surface of the current collecting foil, the protection tape includes a substrate layer and an adhesion layer, the protection tape is adhered to the lead terminal provided at the second region of the current collecting foil, and at least a portion of a third region, the third region being a part of the second region and not covered with the lead terminal.

In view of the above, another aspect of the present invention relates to a method for producing an electrochemical device including a first electrode, a second electrode, a separator interposed between the first electrode and the second electrode, and an electrolyte, the method including the steps of: preparing an electrode including a current collecting foil and a mixture layer provided on the current collecting foil as at least one electrode of the first electrode and the second electrode, wherein the current collecting foil of the at least one electrode includes a first region covered with the mixture layer and a second region not covered with the mixture layer and exposing a surface of the current collecting foil; electrically connecting a lead terminal to the second region of the current collecting foil; disposing a protection tape so as to cover at least a portion of the lead terminal and allowing the protection tape to adhere to the one electrode at at least a portion of a surface of the lead terminal, and at at least a portion of a third region, the third region being a part of the second region and not covered with the lead terminal; and pressing the third region of the one electrode through the protection tape at the time of or after the adhesion of the protection tape.

With the present invention, while keeping a high capacity, shock resistance of an electrochemical device can be improved.

### BRIEF DESCRIPTION OF DRAWINGS

FIG. 1A is a layout illustrating an example of the electrode used in an electrochemical device in an embodiment of the present invention.

FIG. 1B is a cross sectional view illustrating an example of the electrode used in an electrochemical device in an embodiment of the present invention.

FIG. 2 is a partially cutaway oblique view of an electrochemical device in an embodiment of the present invention.

### DESCRIPTION OF EMBODIMENTS

### Electrochemical Device

An electrochemical device in an embodiment of the present invention includes a first electrode, a second electrode, a separator interposed between the first electrode and the second electrode, an electrolyte, a lead terminal, and a protection tape covering the lead terminal.

In the electrochemical device, at least one electrode of the first electrode and the second electrode may be a polarizable electrode. The polarizable electrode may include an active material capable of adsorbing and desorbing ions. In electrochemical devices, a capacity develops by ion adsorption to the active material at at least one electrode side. Desorption of ions from the active material allows a non-faradaic current to flow.

When both of the first electrode and the second electrode are a polarizable electrode, the electrochemical device may be an electric double-layer capacitor (EDLC), in which an electric double-layer is formed when ions are adsorbed to the active material. When one of the first electrode and the second electrode is a non-polarizable electrode, the electrochemical device may be a lithium ion capacitor (LIC), which develops a capacity by adsorption or desorption of lithium ions at the one electrode side. With the LIC, as the non-polarizable electrode, a negative electrode used in lithium ion secondary batteries can be used.

To one electrode of the first electrode and the second electrode (may be a polarizable electrode or a non-polarizable electrode), a lead terminal is electrically connected. Similarly, to the other electrode of the first electrode and the second electrode, another lead terminal may be electrically connected. The electrochemical device includes a protection tape covering the lead terminal at at least one electrode. The one electrode includes a current collecting foil, and a mixture layer provided on the current collecting foil.

In the following, a case where at least a first electrode includes a protection tape (first protection tape) is described as an example. However, the electrochemical device of this embodiment is not limited to this, and the second electrode may include the protection tape (second protection tape), and both of the first electrode and the second electrode may include the protection tape individually. The first electrode may be a positive electrode or a negative electrode. The first electrode may be a polarizable electrode or a non-polarizable electrode.

In the first electrode, the current collecting foil has a first region covered with the mixture layer, and a second region not covered with the mixture layer and exposing a surface of the current collecting foil. The lead terminal is attached to the second region. A third region is present between the lead terminal and the mixture layer: the third region being a part of the second region but not covered with the lead terminal.

The protection tape covers the lead terminal attached to the second region. The protection tape also covers at least a portion of the third region in the longitudinal direction of the current collecting foil. The longitudinal direction is a direction perpendicular to the winding axis, when the first electrode and the second electrode form a wound type electrode group. The protection tape may be disposed across the mixture layer over the third region between the lead terminal and the mixture layer.

The protection tape includes a substrate layer and an adhesion layer. The protection tape is adhered to the lead terminal provided at the second region of the current collecting foil through the adhesion layer, and adhered to the at least a portion of the third region through the adhesion layer. In this manner, the adhesion between the protection tape and the first electrode becomes stronger, and shock resistance can be improved.

Preferably, the second region has a width W2 of 5000 μm or more in the longitudinal direction of the current collecting foil, in terms of sufficiently making the adhesion between the protection tape and the first electrode strong.

Preferably, the mixture layer has a thickness larger than the thickness of the protection tape, in terms of achieving a high capacity. Preferably, of the second region in which the current collecting foil is exposed, a smaller area of the third region not used for attaching the lead terminal is better, in terms of achieving a high capacity. Meanwhile, a step is formed along a border between the third region where the current collecting foil is exposed and the lead terminal, and along a border between the third region and the mixture layer. The larger the thickness of the mixture layer, the higher the step at the interface between the third region and the mixture layer. The smaller the width of the third region in the longitudinal direction of the current collecting foil, the higher the ratio of the step height relative to the third region width (separation distance between the lead terminal and the mixture layer).

The higher the step, and higher the ratio of the step height relative to the third region width, it becomes more difficult to stably adhere the protection tape to the first electrode in the third region. That is, it becomes difficult to achieve strong adherence between the protection tape and the first electrode. In order to strongly adhere the protection tape in the third region even when the step is made high and/or the ratio of the step height is made high for a high capacity, the third region may be pressed through the protection tape at the time of or after the adhesion of the protection tape.

The second region may be pressed through the protection tape at the time of or after the adhesion of the protection tape. By pressing the second region through the protection tape, the protection tape can be adhered to the lead terminal strongly, and the protection tape can be adhered to the current collecting foil in the third region strongly.

Preferably, the pressure for pressing the second region or the third region is 4 N/cm² or more, or more preferably 6 N/cm² or more. The pressing may be performed, for example, with a roll press. Preferably, the pressure (linear pressure) applied with a roll press is 2 N/cm or more, or more preferably 4 N/cm or more.

By adhering the second region while applying the pressure, a portion of the adhesion layer that was present at the protection tape on the adhesion surface with the lead terminal may move to the third region on an adhesion surface side with the current collecting foil. As a result, the average thickness of the adhesion layer interposed between the current collecting foil and the substrate layer in the third region may be formed thicker than the average thickness of the adhesion layer interposed between the lead terminal and the substrate layer in the second region.

The protection tape may be provided at both surfaces of the current collecting foil. In this case, when the current collecting foil is seen in the normal direction of one surface, the second region in the other surface (reverse side of the one surface) may have a portion overlapping with the second region in the one surface. In this case, by pressing the second region of the first electrode from both sides, the protection tape at the time of or after the adhesion can be easily pressed with the first electrode.

When the protection tape is provided at both surfaces of the current collecting foil, each of the protection tapes provided at both surfaces may protrude from the first electrode to the transverse direction of the current collecting foil (when the first electrode and the second electrode form a wound type electrode group, a direction parallel to the winding axis). In this case, the protection tapes provided at both surfaces may be adhered to each other at the protruding portion. In this manner, adhesion between the protection tape and the first electrode can be made more stronger, and shock resistance can be improved even more.

The material of the substrate layer and the adhesion layer in the protection tape is not particularly limited, but the substrate layer may include polypropylene (PP), in terms of suppressing deterioration of the substrate layer by the electrolyte.

For the solvent of the electrolyte used for the electrochemical device, because of its small viscosity, a lactone compound such as γ-butyrolactone (GBL) may be used. When the electrolyte including the lactone compound is used together with a generally used protection tape including polyethylene terephthalate (PET) in the substrate layer is used, because of a high affinity between the PET and the lactone compound, PET dissolves into the electrolyte, and deterioration of the substrate layer may progress. In contrast, the protection tape including polypropylene in the substrate layer hardly dissolves in the lactone compound, and therefore it can suppress deterioration of the substrate layer.

For the substrate layer, a compound having a Hildebrand solubility parameter (SP value) sufficiently apart from the SP value of the lactone compound may be used. The SP value of the lactone compound γ-butyrolactone (GBL) is 12.6 [(cal/cm)^{1/2}], easily dissoluble to PET with a SP value of 10.7, and hardly soluble to PP with a SP value of 8.0. Preferably, the SP value of the material forming the substrate layer is apart from the SP value of the lactone compound by 2.5 or more, more preferably 3.0 or more in terms of suppressing deterioration of the substrate layer of the protection tape. The SP value of the material forming the substrate layer may be 10.0 or less, or 9.0 or less.

With the present invention, even when the thickness of the current collecting foil is made thin, for example, 20 μm or less, and/or the thickness of the mixture layer is made thick, for example, 60 μm or more for a high capacity, by allowing the protection tape to adhere to the lead terminal, and to the current collecting foil in the third region, shock resistance can be improved, and fractures of the current collecting foil can be suppressed.

The current collecting foil may be an etched foil. The etched foil has less strength compared with a non-etched foil, and easily fractures by external impacts and the like. However, by allowing the protection tape to adhere to the lead terminal, and to the current collecting foil in the third region, shock resistance can be improved, and fractures of the current collecting foil can be suppressed.

In the following, an electrochemical device of embodiments of the present invention will be described in detail with reference to figures. However, the present invention is not limited to the configurations shown in the figures.

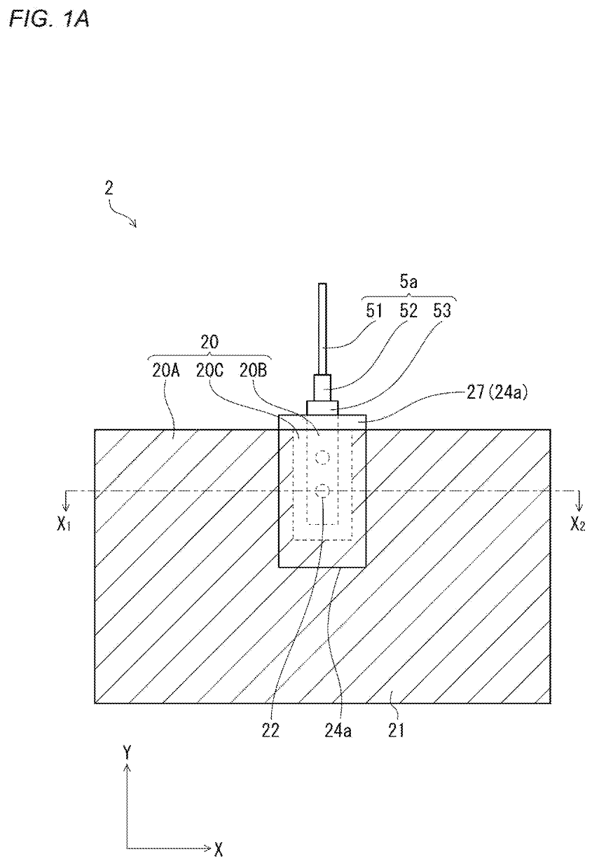

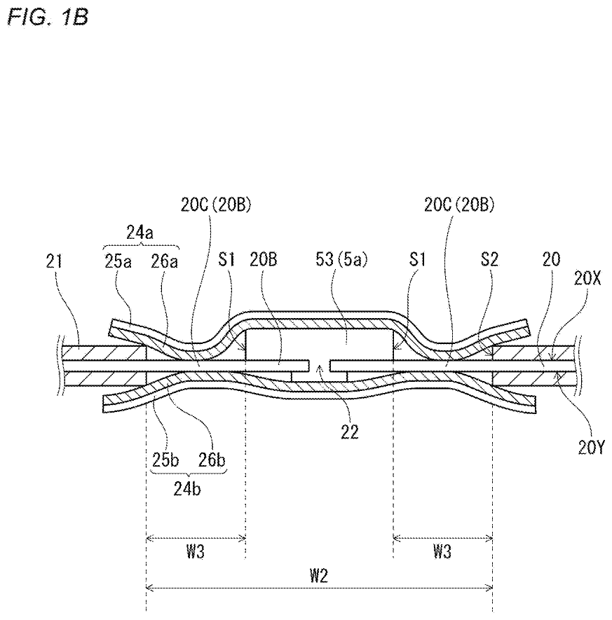

FIG. 1 shows an example of the electrode used in an electrochemical device in an embodiment of the present invention.

FIG. 1A is a layout schematically illustrating a first electrode 2 used in a wound type electrochemical device, in a state before being wound. In FIG. 1A, the X direction is the longitudinal direction of the first electrode, which is a direction perpendicular to the winding axis, and the Y direction is the transverse direction of the first electrode, which is a direction parallel to the winding axis. FIG. 1B is a cross sectional view along line X₁-X₂ in FIG. 1A. In FIG. 1A and FIG. 1B, the connection portion with the lead terminal, which is an essential part of the present invention, is illustrated with emphasis, and the scale of the elements in the figures does not necessarily match the scale of the elements in the actual electrode.

The first electrode 2 includes a current collecting foil 20, and a mixture layer (active material layer) 21 provided on the current collecting foil 20. The current collecting foil 20 is covered with the mixture layer 21 in a first region 20A, but in a second region 20B, not covered with the mixture layer 21 and the surface of the current collecting foil is exposed. In the example of FIG. 1A, the mixture layer 21 is formed on both surfaces of the current collecting foil 20 so as to cover the entirety of the current collecting foil 20, excluding the second region 20B (region without hatching in FIG. 1A).

The current collecting foil 20 has a first main surface 20X, and a second main surface 20Y at an opposite side of the first main surface. The second region 20B is provided at both of the first main surface 20X and the second main surface 20Y. The second region 20B in the first main surface 20X is disposed so as to overlap the second region 20B in the second main surface 20Y when seen from the normal direction of the first main surface 20X.

To the second region 20B of the first main surface 20X, a lead terminal 5a is attached, to achieve electrical connection between the first electrode 2 and the lead terminal 5a.

A third region 20C is present between the lead terminal 5a and the mixture layer 21, the third region 20C being a part of the second region 20B and not covered with the lead terminal 5a. In the third region 20C, the surface of the current collecting foil 20 is exposed even after the attachment of the lead terminal 5a.

As shown in FIG. 1B, a step S1 is formed with a side edge face of the lead terminal 5a, at an interface between the lead terminal 5a and the third region 20C. A step S2 is formed with a side edge face of the mixture layer 21, along a border between the mixture layer 21 and the third region 20C. The larger the thickness of the lead terminal 5a in the second region 20B, the higher the step S1, and the larger the thickness of the mixture layer 21, the higher the step S2. Preferably, to suppress a high step S1, the thickness of the lead terminal 5a in the region where the lead terminal 5a is attached in the second region 20B is 450 μm or less, 350 μm or less, or more preferably 300 μm or less.

For the lead terminal 5a, for example, those having a columnar first portion, and a second portion continuous from the first portion and flatter than the first portion may be used, without limitation. In the example of FIG. 1A, the lead terminal 5a includes a rod 52 of the first portion, and a flat portion 53 of the second portion that is continuous with the rod 52 and formed to be flatter than the rod 52. For example, the second portion (flat portion 53) is formed by forming an end of one cylindrical metal member into flat by pressing, and the first portion (rod 52) can be formed at the other end not being pressed. In the example of FIG. 1A, the lead terminal 5a further includes a CP wire (copper covered steel wire) 51 connected to the rod 52. The CP wire 51 is used for electrical connection with the external circuit.

The flat portion 53 is overlapped with the current collecting foil 20 in the second region 20B. The current collecting foil 20 has through holes 22 that allow communication between the first main surface 20X and the second main surface 20Y in the region of the second region 20B overlapped with the flat portion 53. By placing the flat portion 53 on the current collecting foil 20 and forming a hole together, an acicular projection portion is formed so as to project from the flat portion 53 at a predetermined position of the flat portion 53, and a through hole 22 penetrating both is formed. By crimping the projection portion penetrating the through hole 22 along the second main surface 20Y, the lead terminal 5a is attached to the first electrode 2. In FIG. 1B, the entirety of the through hole 22 is filled with the projection portion, but when a portion of the through hole 22 is filled with the projection portion, an opening that allows the lead terminal 5a (flat portion 53) and the second main surface 20Y to communicate may be formed along the through hole 22.

The larger the thickness of the flat portion 53, the larger the diameter of the wound type electrode group, which is a hindrance to a higher capacity. Also, the height of the step S1 formed between the flat portion 53 and the third region 20C increases, and it becomes difficult to allow the protection tape 24a to adhere to the first electrode 2 in the third region 20C. Preferably, to keep the high capacity and excellent adhesion status between the protection tape 24a and the first electrode 2, the flat portion 53 has a thickness of 450 μm or less, 350 μm or less, or more preferably 300 μm or less.

A pair of protection tapes 24a and 24b cover the second region 20B provided at the first main surface 20X and the second main surface 20Y. The protection tape 24a includes a substrate layer 25a and an adhesion layer 26a. The protection tape 24b includes a substrate layer 25b and an adhesion layer 26b. Of the pair of protection tapes, the protection tape 24a provided on the first main surface 20X covers the lead terminal 5a (flat portion 53) and the third region 20C, and also covers a portion of the mixture layer 21 across the border between the third region 20C and the mixture layer 21. The protection tape 24a is adhered to the lead terminal 5a through the adhesion layer 26a, and also adhered to the current collecting foil 20 in the third region 20C.

When the protection tape 24a and the current collecting foil 20 are allowed to adhere to each other in the third region 20C, because the third region 20C is a depressed region sandwiched between the step S1 formed with the lead terminal 5a and the step S2 formed with the mixture layer 21, it is difficult to realize a strong adhesion status in the third region 20C with a general attaching method. Preferably, to achieve a strong adhesion status, at the time of or after the adhesion of the protection tape 24a, the third region 20C is pressed. The pressing can be performed by pressing at least the third region 20C from both sides of the first main surface 20X and the second main surface 20Y. The entirety of the second region 20B including the third region 20C may be pressed. Preferably, the pressing pressure is 4 N/cm² or more, or more preferably 6 N/cm² or more. The pressing can be performed with a roll press. Preferably, the linear pressure when the pressing is performed with a roll press is 2 N/cm or more, or more preferably 4 N/cm or more.

When the entirety of the second region 20B is pressed, in the protection tape 24a, a portion of the adhesion layer present at the adhesion surface with the lead terminal 5a (flat portion 53) may move to the third region 20C on the adhesion surface side with the current collecting foil 20. In this manner, in the third region 20C, the portion of the protection tape 24a extending obliquely relative to the first main surface 20X of the current collecting foil above the current collecting foil 20 can contribute to adhesion, increasing the adhesion area. Also, in the third region 20C, the adhesion layer interposed between the current collecting foil 20 and the substrate layer has an average thickness T3 that is thicker than the average thickness T2 of the adhesion layer interposed between the lead terminal 5a and the substrate layer. The thickness ratio T3/T2 is, for example, 1.01 or more or 1.05 or more.

Preferably, in terms of achieving a high capacity, in the longitudinal direction of the current collecting foil, the width W3 of the third region 20C interposed between the lead terminal 5a and the mixture layer 21 (separation distance between the lead terminal and the mixture layer) is 2000 μm or less. Meanwhile, in terms of allowing the protection tape to adhere strongly to the first electrode in the third region 20C, preferably, the third region has the width W3 of 1000 μm or more, or more preferably 1200 μm or more.

Preferably, in terms of achieving a high capacity, and allowing the protection tape to adhere strongly to the first electrode in the third region 20C, the ratio of the mixture layer thickness relative to the width W3 of the third region in the longitudinal direction of the current collecting foil (aspect ratio) is 0.02 or more and 0.08 or less, more preferably 0.04 or more and 0.06 or less.

The protection tapes 24a and 24b each has a portion 27 protruding from the first electrode 2 in the transverse direction of the current collecting foil 20. The protruding portions 27 both protrude to the same side in the transverse direction in the protection tapes 24a and 24b, and when seen from the normal direction of the first main surface 20X, the protruding portions 27 are overlapped with each other. In the protruding portion 27, the protection tapes 24a and 24b are adhered. In this manner, adhesion between the protection tapes 24a and 24b and the first electrode 2 becomes even stronger, and shock resistance improves even more.

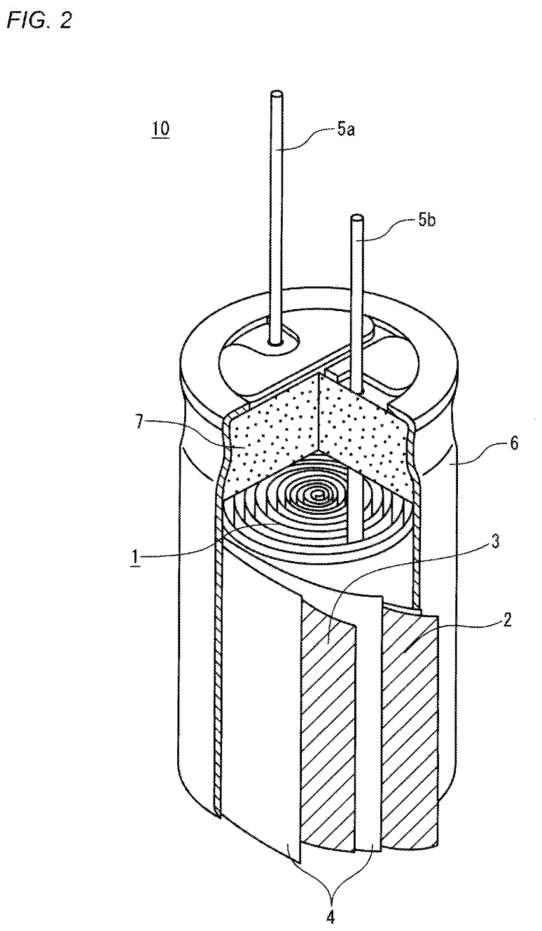

FIG. 2 is a partially cutaway oblique view of an electrochemical device in an embodiment of the present invention.

The electrochemical device 10 of FIG. 2 is an electric double-layer capacitor, and includes a wound type capacitor element 1. The capacitor element 1 has a structure in which a sheet first electrode 2 and a sheet second electrode 3 are wound with a separator 4 interposed therebetween. The first electrode 2 and the second electrode 3 have a first current collector and a second current collector made of metal, respectively, and a first active layer and a second active layer supported on surfaces of the first current collector and the second current collector, respectively, and exhibit a capacity by adsorbing and desorbing ions. The first active layer and the second active layer include, for example, porous carbon particles.

For the current collector, for example, an aluminum foil is used. The surface of the current collector may be roughened by a method such as etching. For the separator 4, for example, a microporous film mainly composed of polypropylene is used. A first lead wire 5a and a second lead wire 5b are connected as lead-out members (lead terminals) to the first electrode 2 and the second electrode 3, respectively. The capacitor element 1 is housed in a cylindrical outer case 6 together with an electrolyte (not shown). The material of the outer case 6 may be, for example, metal such as aluminum, stainless steel, copper, iron, or brass. The opening of the outer case 6 is sealed with a sealing member 7. The lead wires 5a and 5b are led out to the outside to penetrate the sealing member 7. For the sealing member 7, for example, a rubber material such as butyl rubber is used.

### Electrochemical Device Production Method

A method for producing an electrochemical device in an embodiment of the present invention is a method for producing the above described electrochemical device. The production method includes preparing an electrode including a current collecting foil, and a mixture layer provided on the current collecting foil, as one electrode of the first electrode and the second electrode. The current collecting foil of the prepared one electrode has a first region covered with the mixture layer, and a second region not covered with the mixture layer and exposing a surface of the current collecting foil.

The production method further includes (i) electrically connecting a lead terminal to a second region of the current collecting foil, (ii) disposing a protection tape so as to cover at least a portion of the lead terminal, and allowing the protection tape to adhere to the one electrode at at least a portion of a surface of the lead terminal, and at at least a portion of the third region that is a part of the second region and not covered with the lead terminal, and (iii) pressing the third region of the one electrode at the time of or after the adhesion of the protection tape through the protection tape. Preferably, the pressure in step (iii) is 4 N/cm² or more, more preferably 6 N/cm² or more. The pressing in step (iii) may be performed by using a roll. Preferably, in that case, the pressure (linear pressure) is 2 N/cm or more, or more preferably 4 N/cm or more.

The one electrode produced in step (iii) is laminated with the other electrode with the separator interposed therebetween, to produce a laminate. The laminate may be a wound body, in which one electrode and the other electrode are wound with the separator interposed therebetween. The laminate is housed in the outer case, and an electrolyte is injected in the outer case. Afterwards, the outer case is sealed to produce an electrochemical device.

Hereinafter, elements of the electrochemical device will be described in detail.

### (Electrode)

For the first electrode and the second electrode of the electrochemical device, for example, an electrode including an active layer including an active material, and a current collector supporting the active layer is used as a polarizable electrode. The active material includes, for example, porous carbon particles. The active layer may include an active material of porous carbon particles as an essential component, and may include a binder, a conductive agent, and the like as optional components.

The porous carbon particles can be produced, for example, by subjecting a raw material to a heat treatment to carbonize the raw material, and subjecting the obtained carbide to an activation treatment to obtain the porous particles. The carbide may be pulverized and sized before the activation treatment. The porous carbon particles produced by the activation treatment may be pulverized. After the pulverization treatment, a classification treatment may be performed. Examples of the activation treatment include gas activation using a gas such as water vapor, and chemical activation using an alkali such as potassium hydroxide.

Examples of the raw material include wood, coconut shell, pulp waste liquid, coal or coal-based pitch obtained through thermal decomposition of coal, heavy oil or petroleum-based pitch obtained through thermal decomposition of heavy oil, phenol resin, petroleum coke, and coal coke. In particular, the raw material of petroleum coke, and coal coke are preferable.

The petroleum coke, or coal coke may be heat treated, and the produced carbide may be subjected to the activation treatment, and then the porous carbon particles may be pulverized. For the pulverization treatment, for example, a ball mill or a jet mill is used. The above-described pulverization treatment produces fine porous carbon particles, having an average particle size (D50) of, for example, 1 μm or more and 4 μm or less. In this specification, the average particle size (D50) means a particle size (median size) having a volume integrated value of 50% in the volume-based particle size distribution measured by the laser diffraction scattering method.

The pore distribution and the particle size distribution of the porous carbon particles can be adjusted by, for example, the raw material, the heat treatment temperature, the activation temperature in gas activation, and the degree of pulverization. Two kinds of porous carbon particles of different raw materials may be mixed and the pore distribution and the particle size distribution of the porous carbon particles may be adjusted. The average particle size and the particle size distribution of the porous carbon particles are measured by the laser diffraction/scattering method. For the measurement device, for example, a laser diffraction/scattering particle size distribution measurement device “MT3300EXII” manufactured by Microtrac is used.

For the binder, for example, a resin material such as polytetrafluoroethylene (PTFE), carboxy methylcellulose (CMC), and styrene-butadiene rubber (SBR) are used. For the conductive agent, for example, carbon black such as acetylene black is used.

The electrode is obtained, for example, by applying a slurry containing porous carbon particles, a binding agent, and/or a conductive agent, and a dispersion medium to a surface of a current collector, drying the coating film, followed by rolling, to thereby form an active layer. For the current collector, for example, a metal foil such as an aluminum foil is used.

When the electrochemical device is an electric double-layer capacitor (EDLC), for at least one of the first electrode and the second electrode, the above-described electrode including the porous carbon particles can be used. When the electrochemical device is a lithium ion capacitor (LIC), the above-described electrode including the porous carbon particles may be used for one (positive electrode) of the first electrode and the second electrode, and a negative electrode used for lithium ion secondary batteries may be used for the other (negative electrode) of the first electrode and the second electrode. The negative electrode used in a lithium ion secondary battery contains, for example, a negative electrode active material (for example, graphite) capable of storing and releasing lithium ions.

### (Electrolyte)

The electrolyte includes a solvent (non-aqueous solvent) and an ionic substance. The ionic substance is dissolved in the solvent and contains a cation and an anion. The ionic substance may contain, for example, a low melting point compound (ionic liquid) that can exist as a liquid at around room temperature. The concentration of the ionic substance in the electrolytic solution is, for example, 0.5 mol/L or more and 2.0 mol/L.

The solvent is preferably a high boiling point solvent. The solvent may include a lactone compound. Examples of the lactone compound include β-propiolactone, γ-butyrolactone, γ-valerolactone, and δ-valerolactone. Preferably, the lactone compound includes γ-butyrolactone (GBL), because it has a low viscosity even under a low temperature, is stable electrochemically in the voltage range of the device, and has less gas release amount.

The solvent may include other solvent other than the lactone compound. For the other solvent, for example, chain carboxylates such as methyl propionate; chain carbonates such as diethyl carbonate; cyclic carbonates such as propylene carbonate; polyhydric alcohols such as ethylene glycol, and propylene glycol; cyclic sulfones such as sulfolane; amides such as N-methylacetamide, N,N-dimethylformamide, and N-methyl-2-pyrrolidone; ethers such as 1,4-dioxane; ketones such as methyl ethyl ketone; and formaldehyde can be used. When the solvent is a solvent mixture of a lactone compound and other solvent, the ratio of the lactone compound to the entire solvent may be, for example, 50 vol % or more and 85 vol % or less.

The solvent may include acetonitrile.

The ionic substance contains, for example, an organic salt. The organic salt is a salt in which at least one of an anion and a cation contains an organic substance. Examples of the organic salt in which a cation contains an organic substance include quaternary ammonium salts. Examples of the organic salt in which an anion (or both ions) contains an organic substance include trimethyl amine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

From the viewpoint of improving the withstand voltage characteristics, the anion preferably includes a fluorine-containing acid anion. For the fluorine-containing acid anion, for example, BF₄— and/or PF₆— are used. The organic salt preferably contains, for example, a tetraalkylammonium cation and a fluorine-containing acid anion. Specific examples thereof include diethyldimethylammonium tetrafluoroborate (DEDMABF₄) and triethylmethylammonium tetrafluoroborate (TEMABF₄).

When the electrochemical device is a lithium ion capacitor (LIC), the ionic substance includes a lithium salt. Preferably, the lithium salt is a salt having a fluorine-containing anion. Preferably, of the salt having a fluorine-containing anion, at least one selected from the group consisting of LiBF₄, LiPF₆, and lithiumbis (fluoro sulfonyl) imide (LiN(SO₂F)₂) is more preferable. LiN(SO₂F)₂ is also called LiFSI or LFSI. Of the salt having a fluorine-containing anion, in particular, LFSI hardly produces by-products, and is excellently stable.

### (Separator)

A separator is interposed between the first electrode and the second electrode. The separator has ion permeability, and works to physically separate the pair of electrodes to prevent short circuits. The separator form is not particularly limited, and may be, for example, nonwoven cloth or woven cloth, or a microporous film.

In the above-described embodiment, a wound type electrochemical device is described, but the application of the present invention is not limited to the above-described, and may be applied to a device with another structure, for example, a laminate type electrochemical device.

### Industrial Applicability

The electrochemical device according to the present invention is suitably used for applications requiring a large capacity and excellent shock resistance.

### REFERENCE SIGNS LIST

1: capacitor element, 2: first electrode, 3: second electrode, 4: separator, 5a: first lead wire, 5b: second lead wire, 6: outer case, 7: sealing member, 10: electrochemical device, 20: current collecting foil, 21: mixture layer, 22: through hole, 24a, 24b: protection tape, 25a, 25b: substrate layer, 26a. 26b: adhesion layer, 27: protruding portion, 51: CP wire, 52: rod, 53: flat portion

1. An electrochemical device comprising:
a first electrode,
a second electrode,
a separator interposed between the first electrode and the second electrode,
an electrolyte,
a lead terminal electrically connected to at least one electrode of the first electrode and the second electrode, and
a protection tape covering the lead terminal, wherein
the at least one electrode includes a current collecting foil and a mixture layer provided on the current collecting foil,
the current collecting foil has a first region covered with the mixture layer, and a second region not covered with the mixture layer and exposing a surface of the current collecting foil,
the protection tape includes a substrate layer and an adhesion layer, and
the protection tape is allowed to adhere to the lead terminal provided at the second region of the current collecting foil, and to at least a portion of a third region, the third region being a part of the second region not covered with the lead terminal.

2. The electrochemical device of claim 1, wherein the lead terminal includes a columnar first portion, and a second portion that is continuous from the first portion and flatter than the first portion,
the second portion is fixed to the second region of the current collecting foil, and
the second portion has a thickness of 450 μm or less.

3. The electrochemical device of claim 2, wherein at least a portion of the second portion of the lead terminal is overlapped with the current collecting foil of the second region,
the current collecting foil has a through hole in a region overlapped with the at least a portion of the second portion,
the lead terminal further includes a projection portion projecting from the second portion and penetrating the through hole, and the projection portion is crimped to the current collecting foil through the through hole.

4. The electrochemical device of claim 1, wherein the second region has a width of 5000 μm or more in a longitudinal direction of the current collecting foil.

5. The electrochemical device claim 1, wherein the third region interposed between the lead terminal and the mixture layer has a width of 2000 μm or less in the longitudinal direction of the current collecting foil.

6. The electrochemical device of claim 1, wherein the protection tape is provided on both surfaces of the current collecting foil, and
the protection tape protrudes from the one electrode in a transverse direction of the current collecting foil, and the protection tapes provided on the both surfaces are adhered to each other at the protruding portion.

7. The electrochemical device of claim 1, wherein the adhesion layer interposed between the current collecting foil and the substrate layer in the third region has an average thickness that is larger than an average thickness of the adhesion layer interposed between the lead terminal and the substrate layer.

8. The electrochemical device of claim 1, wherein the one electrode is a polarizable electrode.

9. The electrochemical device of claim 8, wherein both of the first electrode and the second electrode are a polarizable electrode.

10. The electrochemical device of claim 1, wherein the electrolyte includes a lactone compound, and
the substrate layer of the protection tape includes polypropylene.

11. A method for producing an electrochemical device, the electrochemical device comprising: a first electrode, a second electrode, a separator interposed between the first electrode and the second electrode, and an electrolyte, the method including:
preparing an electrode including a current collecting foil and a mixture layer provided on the current collecting foil, as at least one electrode of the first electrode and the second electrode, wherein the current collecting foil of the at least one electrode has a first region covered with the mixture layer and a second region not covered with the mixture layer and exposing a surface of the current collecting foil,
electrically connecting a lead terminal to the second region of the current collecting foil,
disposing a protection tape so as to cover at least a portion of the lead terminal, and allowing the protection tape to adhere to the one electrode at at least a portion of a surface of the lead terminal, and at at least a portion of a third region, third region being a part of the second region not covered with the lead terminal, and
pressing the third region of the one electrode through the protection tape at the time of or after the adhesion of the protection tape.
